(19) United States
(12) Patent Application Publication
(10) Pub. No.: US 2008/0022876 A1
(43) Pub. Date: Jan. 31, 2008

(54) PRINTING PRESS

(75) Inventors: Minoru YOKOYAMA, Hiroshima (JP); Kazuma Yoshimoto, Hiroshima (JP); Yasunori Masuda, Hiroshima (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES. LTD., TOKYO (JP)

(21) Appl. No.: 11/782,427

(22) Filed: Jul. 24, 2007

(30) Foreign Application Priority Data
Jul. 28, 2006 (JP) 2006-206878

(51) Int. Cl. B41F 27/00

(52) U.S. Cl. 101/477

(57) ABSTRACT

A new-plate holding unit holds a surface of a new plate in a width direction on a new-plate insertion path. A movement constraining unit constrains the new-plate holding unit to move in a direction of inserting the new plate, with a margin in the width direction of the new plate. A pressing unit presses the new-plate holding unit in a direction in which the new-plate holding unit is constrained with a constant force by a distance equivalent to a moving distance of the new plate. A position returning unit presses the new-plate holding unit to be returned from a position where the new-plate holding unit is pressed to a position before being pressed.

### BACKGROUND OF THE INVENTION

1. Field of the Invention

The present invention relates to a printing press, and more particularly, to a printing press including a plate replacing apparatus for replacing an old plate with a new plate.

2. Description of the Related Art

In a conventional printing press including a plate replacing apparatus as disclosed in Japanese Patent Application Laid-Open No. 2000-255031, the plate replacing apparatus includes at least one of a mechanism for removing an old plate and a mechanism for inserting a new plate towards a plate cylinder. When a new plate is inserted towards the plate cylinder, the new plate needs to be positioned on the plate cylinder precisely. If the new plate is not positioned precisely, a printing result is adversely affected. On the other hand, when an old plate is removed from the plate cylinder by the above mechanism, a worker needs to take out the removed plate eventually.

Particularly, in a type of a conventional printing press including a plate replacing apparatus in which the plate cylinder is driven by a gear, it may happen that a new plate is not appropriately positioned on the plate cylinder due to a structural defect, for example, because a rotational positioning error occurs in the plate cylinder when a plate is to be replaced, or a plate is stuck in the middle of a plate insertion path in the plate replacing apparatus. Also, in some types of plate replacing apparatuses, even though a plate is not positioned in an appropriate position, the plate is squeezed towards the plate cylinder. As a result, the plate or a positioning notch of the plate is deformed, and thus it may cause an adverse affect on the plate positioning.

Furthermore, the worker eventually takes out an old plate by hand, a mechanism for holding the old plate is released so that the old plate can be easily taken out by the worker. At this time, there is a possibility that the worker drops the old plate on a floor by mistake, and thus the plate may be damaged.

### SUMMARY OF THE INVENTION

It is an object of the present invention to at least partially solve the problems in the conventional technology.

A printing press according to one aspect of the present invention includes a plate replacing apparatus. The plate replacing apparatus includes a new-plate holding unit that holds a surface of a new plate in a width direction on a new-plate insertion path; a movement constraining unit that constrains the new-plate holding unit to move in a direction of inserting the new plate between the new-plate holding unit and a frame in which the new-plate holding unit is mounted, with a margin in the width direction of the new plate; a pressing unit that presses the new-plate holding unit in a direction in which the new-plate holding unit is constrained with a constant force by a distance equivalent to a moving distance of the new plate held by the new-plate holding unit to be inserted towards a plate cylinder; and a position returning unit that presses the new-plate holding unit to be returned from a position where the new-plate holding unit is pressed to a position where the new-plate holding unit is located before being pressed.

A printing press according to another aspect of the present invention includes a plate replacing apparatus. The plate replacing apparatus includes a new-plate holding unit that holds a surface of a new plate in a width direction on a new-plate insertion path; a movement constraining unit that constrains the new-plate holding unit to move in a direction of inserting the new plate by fitting a columnar lug protruded from the new-plate holding unit in the width direction of the new plate in a groove provided on a frame in which the new-plate holding unit is mounted; and a plate-introduction rotating unit that is an approximately horseshoe-shaped rotating unit. The plate-introduction rotating unit holds the columnar lug protruded from the new-plate holding unit on its lower jaw before the new plate is inserted towards the plate cylinder, releases the columnar lug protruded from the new-plate holding unit in the direction in which the new plate is inserted by rotating downwards when the new plate is inserted towards the plate cylinder, and defines an angle when the plate-introduction rotating unit stops rotating as an angle when the columnar lug contacts neither an upper jaw nor the lower jaw in a state that a notch provided at a tip of the new plate is fitted in a pin of the plate cylinder, and also when the columnar lug is pressed by the upper jaw in a state that the notch is located short of a position where the notch is fitted in the pin.

A printing press according to still another aspect of the present invention includes a plate replacing apparatus. The plate replacing apparatus includes a new-plate holding unit that holds a surface of a new plate in a width direction on a new-plate insertion path; a movement constraining unit that constrains the new-plate holding unit to move in a direction of inserting the new plate by fitting a columnar lug protruded from the new-plate holding unit in the width direction of the new plate in a groove provided on a frame in which the new-plate holding unit is contained, with a margin in the width direction of the new plate; and a plate-introduction rotating unit that is an approximately horseshoe-shaped rotating unit. The plate-introduction rotating unit holds the columnar lug protruded from the new-plate holding unit on its lower jaw before the new plate is inserted towards the plate cylinder, releases the columnar lug protruded from the new-plate holding unit in the direction in which the new plate is inserted by rotating downwards when the new plate is inserted towards the plate cylinder, and defines an angle when the plate-introduction rotating unit stops rotating as an angle when the columnar lug contacts neither an upper jaw nor the lower jaw in a state that a notch provided at a tip of the new plate is fitted in a pin of the plate cylinder, and also when the columnar lug is pressed by the upper jaw in a state that the notch is located short of a position where the notch is fitted in the pin.

A printing press according to still another aspect of the present invention includes a plate replacing apparatus. The plate replacing apparatus includes a new-plate holding unit that holds a surface of a new plate in a width direction on a new-plate insertion path; and a roller guide that exposes the surface of the new plate held by the new-plate plate holding unit. The roller guide includes a torque limiter.

A printing press according to still another aspect of the present invention includes a plate replacing apparatus that includes a mechanism for removing an old plate wound around a plate cylinder. The mechanism includes plate-holding guide rollers for holding the old plate. A one-way clutch is provided on at least one of the plate-holding guide rollers.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a printing press according to an embodiment of the present invention, including a plate replacing apparatus;

FIG. 2 is a schematic diagram of a protective cover of the printing press shown in FIG. 1;

FIG. 3 is a schematic diagram of the protective cover shown in FIG. 2 when an upper portion of the protective cover rotates;

FIG. 4 is a perspective view of the plate replacing apparatus viewed from an operating side;

FIG. 5 is a perspective view of the plate replacing apparatus viewed from an opposite side of the operating side shown in FIG. 4;

FIG. 6 is a side view of the protective cover when a new plate is set up;

FIG. 7 is a side view of the plate replacing apparatus when an old plate is to be removed;

FIG. 8 is a side view of the plate replacing apparatus when winding the new plate around a plate cylinder;

FIG. 9 is a side view of the plate replacing apparatus when the new plate is completely wound around the plate cylinder;

FIG. 10 is a side view of the plate replacing apparatus;

FIG. 11 is an enlarged front view of the partial plate replacing apparatus shown in FIG. 10;

FIG. 12A is a cross-sectional view of the plate replacing apparatus along the line E-E shown in FIG. 11;

FIG. 12B is a cross-sectional view of the plate replacing apparatus along the line W-W shown in FIG. 11;

FIG. 12C is a cross-sectional view of the plate replacing apparatus along the line V-V shown in FIG. 11;

FIG. 13A is a front view of a new-plate holding unit of the plate replacing apparatus;

FIG. 13B is a simplified front view of the new-plate holding unit shown in FIG. 13A;

FIG. 13C is a cross-sectional view of the new-plate holding unit along the line Y-Y shown in FIG. 13B;

FIG. 14 is a rear view of the new-plate holding unit of the plate replacing apparatus shown in FIG. 13A;

FIG. 15 is a cross-sectional view of the new-plate holding unit of the plate replacing apparatus along the line H-H shown in FIG. 13A;

FIG. 16 is a cross-sectional view of the new-plate holding unit of the plate replacing apparatus along the line H-H shown in FIG. 13A;

FIG. 17 is a diagram for explaining a relation between a columnar lug and a plate-introduction rotating unit in the plate replacing apparatus;

FIG. 18 is another diagram for explaining the relation between the columnar lug and the plate-introduction rotating unit;

FIG. 19 is a schematic diagram for explaining a configuration of a plate-insertion type of a plate replacing apparatus with a torque limiter according to a variation of the present invention;

FIG. 20 is a cross-sectional view of the plate replacing apparatus along the line A-A shown in FIG. 19;

FIG. 21A is a cross-sectional view of the plate replacing apparatus along the line B-B shown in FIG. 19;

FIG. 21B is a cross-sectional view of the plate replacing apparatus along the line D-D shown in FIG. 21A; and

FIG. 22 is a perspective view of the plate replacing apparatus.

### DETAILED DESCRIPTION OF THE PREFERRED EMBODIMENTS

Exemplary embodiments of the present invention are explained in detail below with reference to the accompanying drawings. The present invention is not limited to the embodiments. Components capable of being easily conceived by those skilled in the art are to be employed in the embodiments.

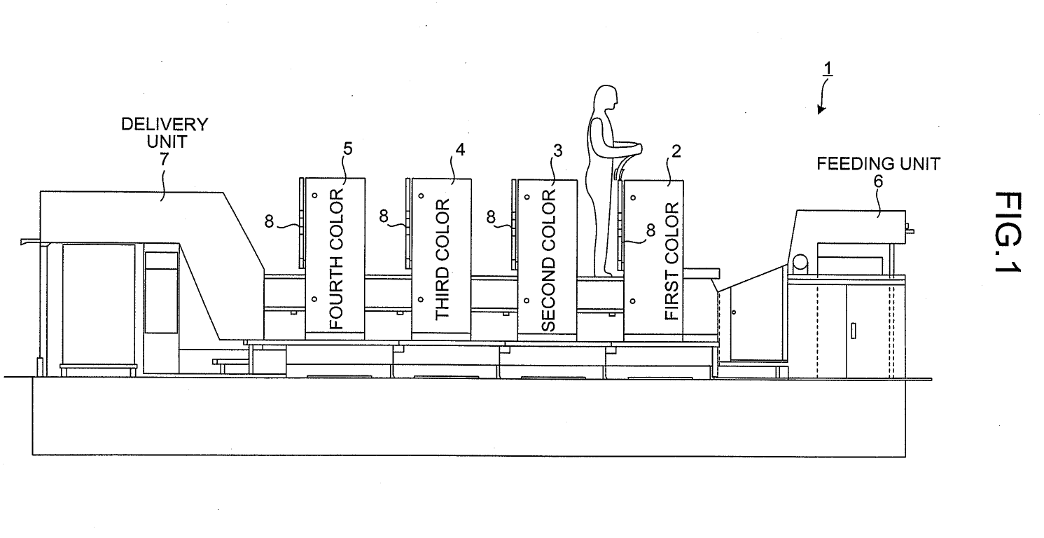

FIG. 1 is a side view of a printing press 1 according to an embodiment of the present invention, including a plate replacing apparatus. The printing press 1 includes a feeding unit 6, printing units 2, 3, 4, and 5, and a delivery unit 7. The feeding unit 6 feeds paper to be printed thereon to the printing unit. The printing units 2, 3, 4, and 5 respectively print an image in different colors, such as in cyan, magenta, yellow, and black, on the paper fed from the feeding unit 6 by overlapping each color sequentially. The printed paper is output by the delivery unit 7. Each of the printing units 2, 3, 4, and 5 respectively includes a number of rollers, such as a plate cylinder and an impression cylinder, those required for printing. These rollers are covered by a protective cover 8.

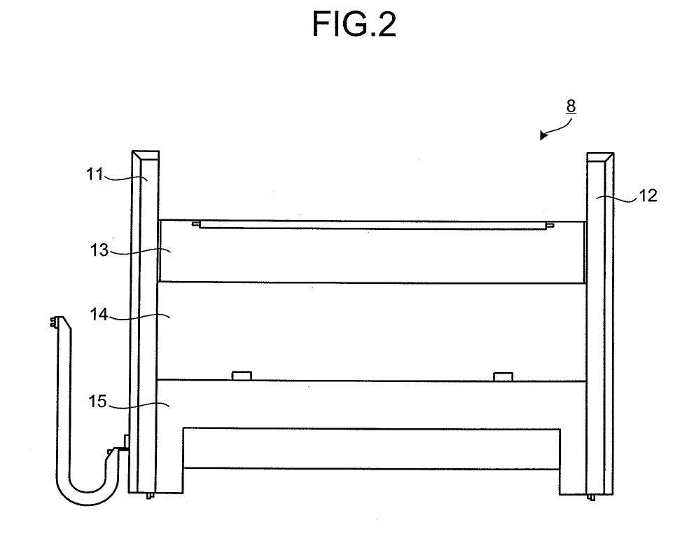

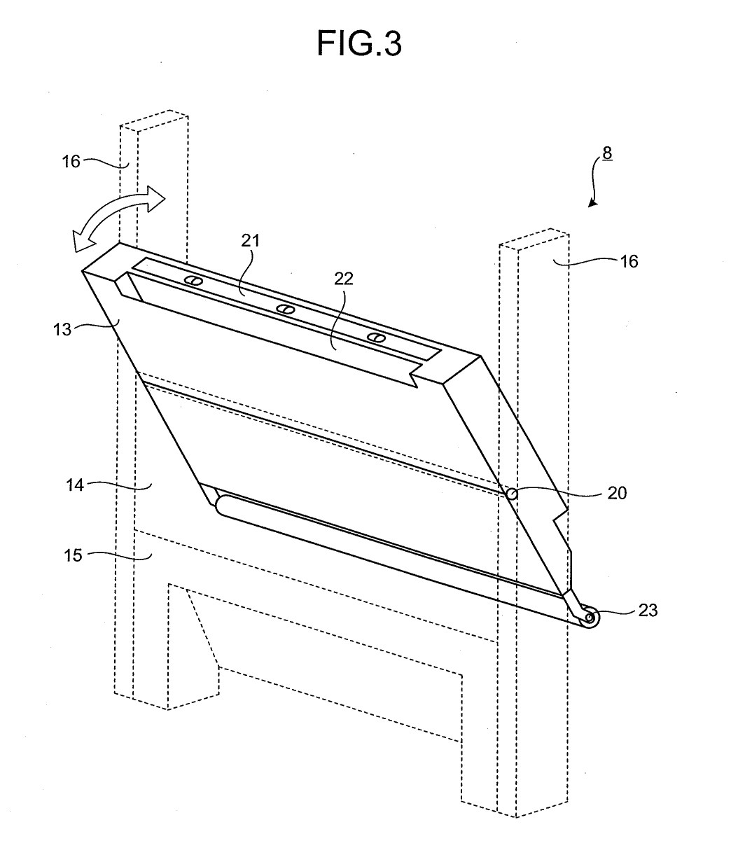

FIG. 2 is a schematic diagram of the protective cover 8. The protective cover 8 is separated into an upper portion 13, a middle portion 14, and a lower portion 15. Both ends of the portions 13 to 15 are coupled to rectangular column-shaped frames 16 that are building frames of each of the printing units 2 to 5 (see FIG. 3). The frames 16 are covered by covers 11 and 12 respectively.

FIG. 3 is a schematic diagram of the protective cover 8 when the upper portion 13 rotates. The upper portion 13 serves as the plate replacing apparatus. As shown in FIG. 3, an old-plate removing slot 21 and a new-plate inserting slot 22 are provided on top of the upper portion 13.

The upper portion 13 is configured to rotate around a rotation shaft 20 and slant at a predetermined angle with respect to the middle portion 14 and the lower portion 15. A plate-replacement supporting roller 23 is provided at the end of the upper portion 13. An old plate wound around the plate cylinder (not shown) is pressed by the plate-replacement supporting roller 23, and thus the old plate can be easily removed from the plate cylinder. Except when a plate is to be replaced, the upper portion 13 serves as an upper structure of the protective cover.

The plate-replacement supporting roller 23 also presses a new plate on the plate cylinder to support the new plate to be wound around the plate cylinder. Moreover, when a chuck of a vice of the plate cylinder is closed at the last step of inserting the new plate, the plate-replacement supporting roller 23 also presses the plate on the chuck.

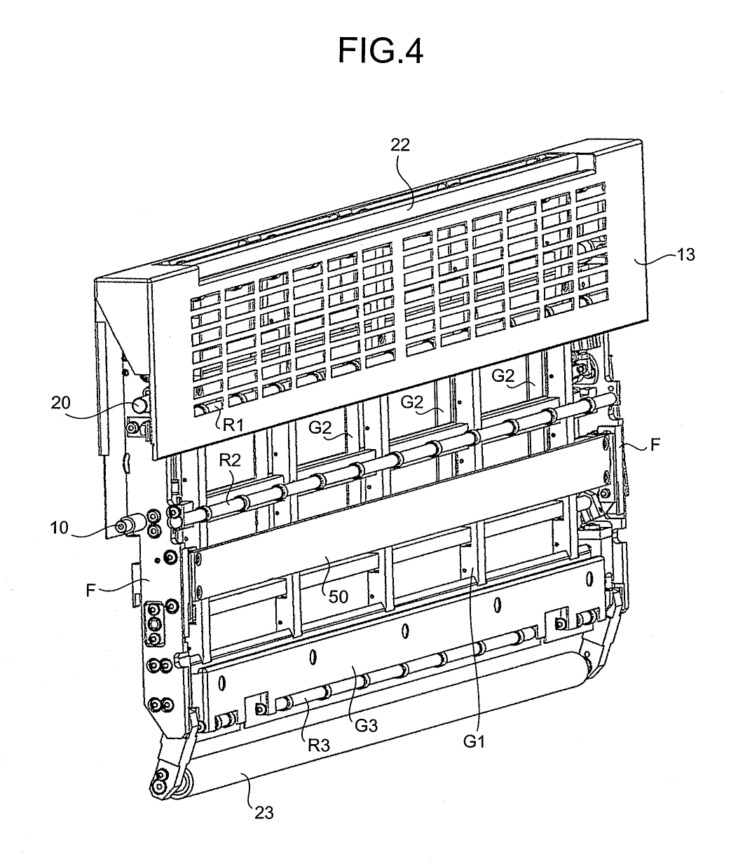

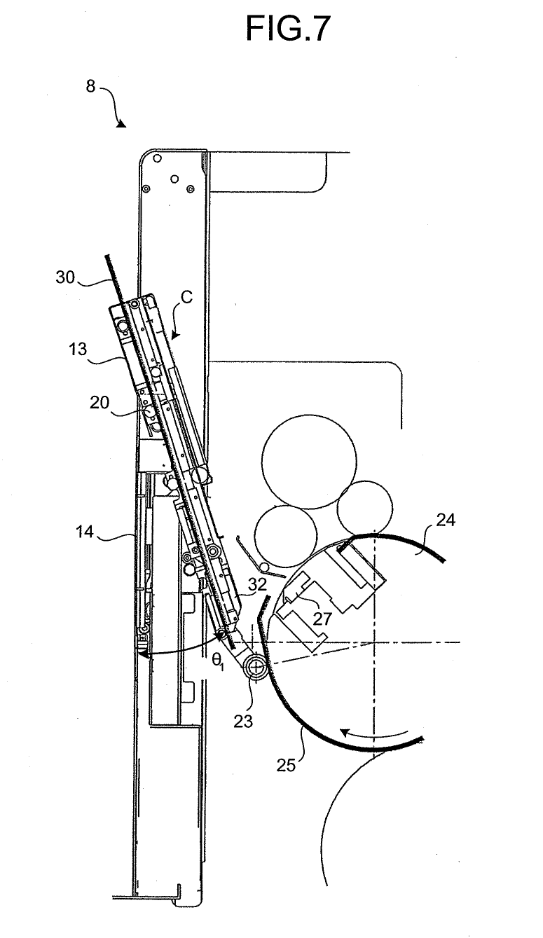

FIG. 4 is a perspective view of the upper portion 13 of the plate replacing apparatus viewed from an operating side. According to the present embodiment, an air cylinder is used as an actuator for driving the plate replacing apparatus to rotate. With a link shaft 10 capable of establishing an appropriate link by a translatory stretching movement of the air cylinder (see FIGS. 7 to 11), a desired rotation angle centering around the rotation shaft 20 can be obtained (see FIG. 3).

A new plate inserted from the new-plate inserting slot 22 is guided by feed rollers R1, R2, and R3, which are rotatably attached to a sub-frame F composing the lateral side of the upper portion 13, and inserted into a gap between a plurality of guides G1 and a guide G3 to be along a connecting plate 50, and then held at a predetermined position.

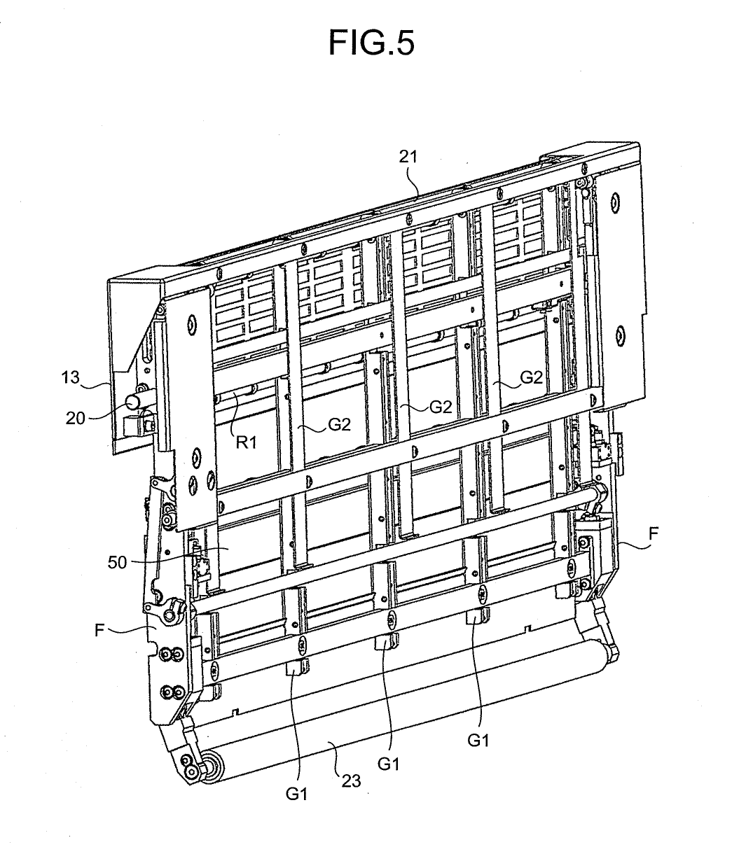

FIG. 5 is a perspective view of the upper portion 13 of the plate replacing apparatus viewed from an opposite side of that is shown in FIG. 4. The upper portion 13 rotates with respect to the plate cylinder of the printing press. An old plate is guided by the guides G1 and a plurality of guides G2, which are arranged in a direction along the sub-frame F, by being supported by the plate-replacement supporting roller 23. More specifically, the old plate is guided by rollers (not shown), which are provided on surfaces of the guides G1 facing to an obverse side of the old plate, and the guides G2, and moves through gaps between the guides G1 and G2, and finally a tip of the old plate reaches to an opening area of the old-plate removing slot 21.

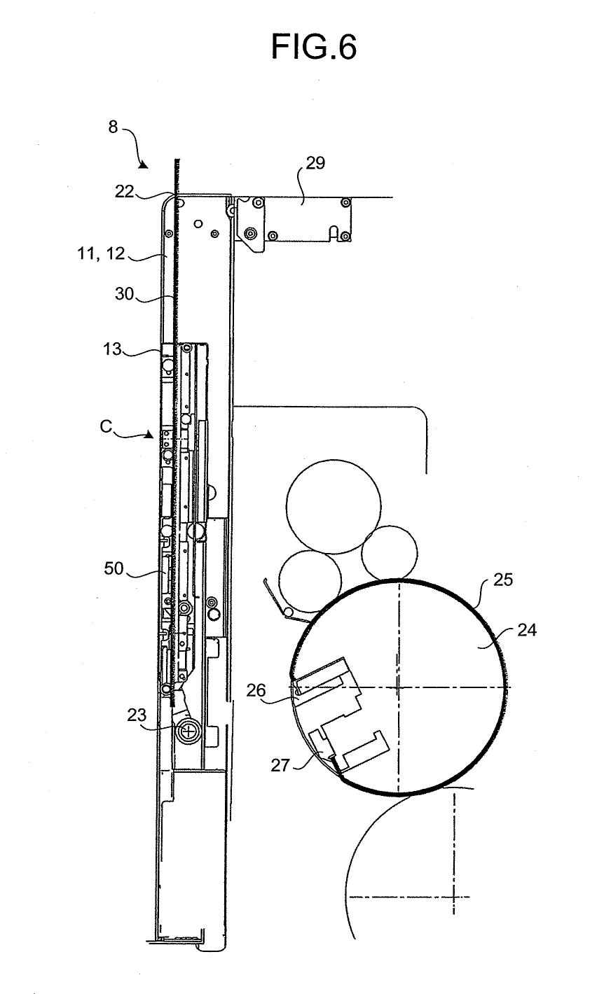

FIG. 6 is a side view of the protective cover 8 when a new plate is set up. In this case, a plate replacing apparatus C includes the upper portion 13 of the protective cover 8, the air cylinder, and the like. In a case in which the plate replacing apparatus C does not rotate, the plate replacing apparatus C is integrated with the middle portion 14 and the lower portion 15 of the protective cover 8, and thereby composing the protective cover 8 (a plate-replacement standby status). At this time, the plate-replacement supporting roller 23 is contained inside the protective cover 8. According to the present embodiment, the new-plate inserting slot 22 is opened outwardly even when the plate replacing apparatus C rotates so that a new plate 30 can be inserted into the plate replacing apparatus C. When the new plate 30 is inserted into the plate replacing apparatus C at a predetermined depth, a new-plate holding unit N provided adjacent to the connecting plate 50 holds the new plate, and stands by for subsequent inserting towards the plate cylinder.

As shown in FIG. 6, a plate cylinder 24 is also arranged inside the protective cover 8. A tip and a trailing end of an old plate 25 are respectively held by chucks 26 and 27 of the vice, and the old plate 25 is wound around the plate cylinder 24.

FIG. 7 is a side view of the plate replacing apparatus C when the old plate 25 is going to be removed. The plate replacing apparatus C rotates around the rotation shaft 20 at an angle θ₁ by the actions of the link shaft 10 shown in FIG. 4 and a link mechanism (not shown). At this time, the plate-replacement supporting roller 23 moves to press the old plate 25 wound around the plate cylinder 24. Exactly, the plate-replacement supporting roller 23 contacts the old plate 25 wound around the plate cylinder 24, and presses at a certain degree of a press force. In this state, the trailing-end-side chuck 27, which is located on the side of the trailing end of the old plate 25, is released.

The old plate 25 released from the trailing-end-side chuck 27 is supported by the plate-replacement supporting roller 23 from beneath, and naturally enters into an old-plate receiving inlet 32 of the plate replacing apparatus C. Exactly, the old plate 25 enters into the old-plate receiving inlet 32 by the actions of a weight and a stiffness of the plate. Then, the plate cylinder 24 rotates clockwise, and the old plate 25 is inserted into the plate replacing apparatus C, and then held by an inner roller serving as a guide. Finally, a step of removing the old plate 25 is completed. Incidentally, at this time, the new plate 30 is still set up inside the plate replacing apparatus C.

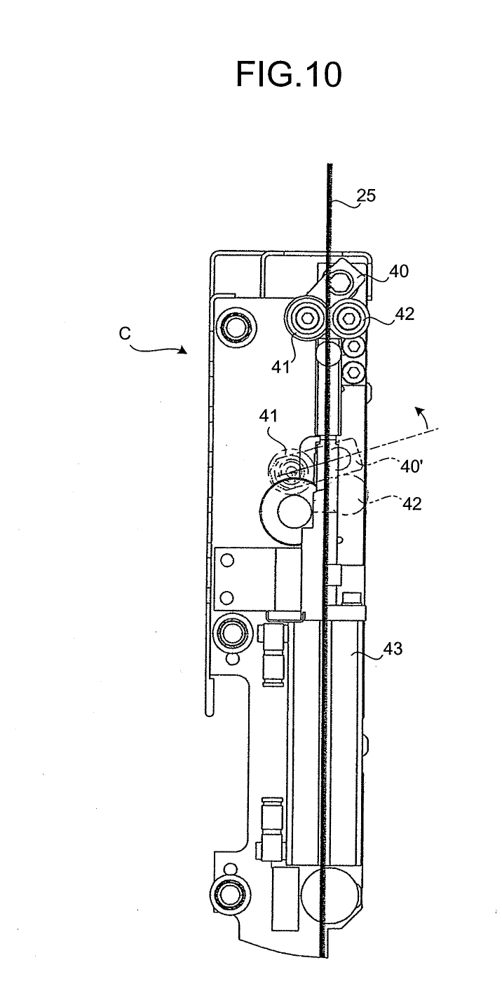

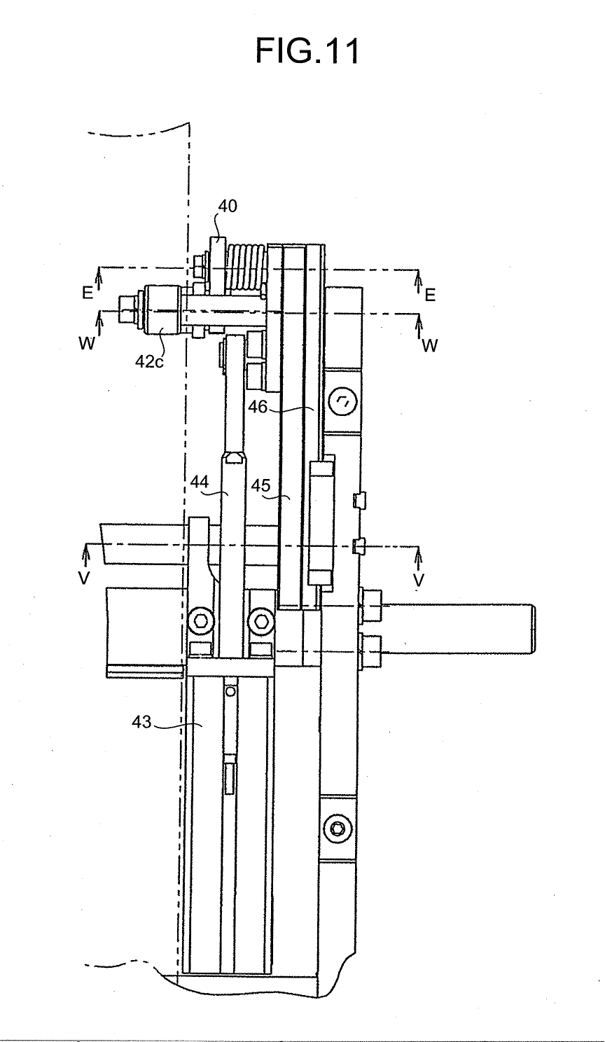

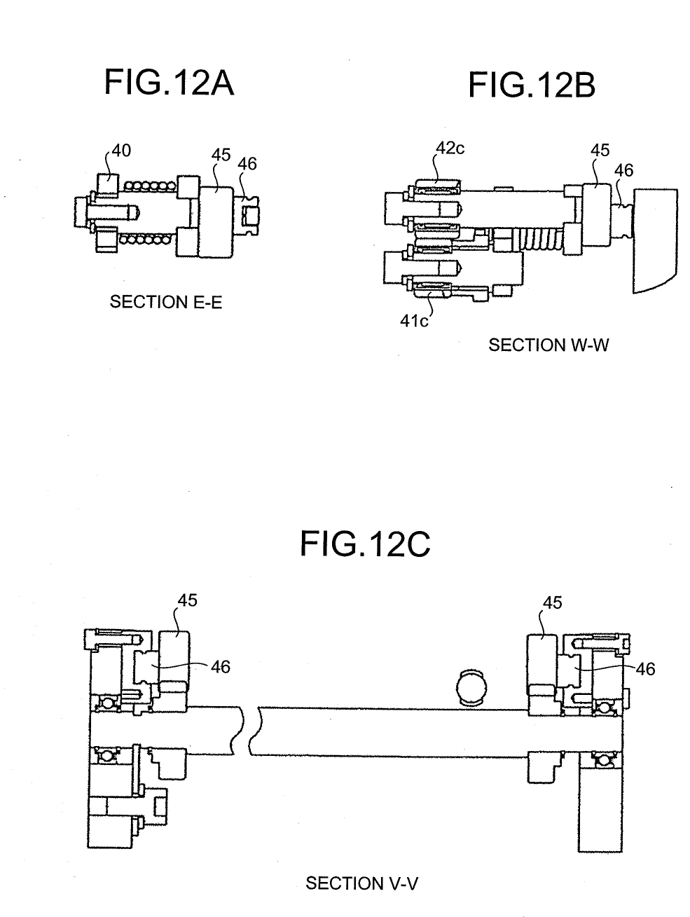

FIG. 10 is a side view for explaining an internal configuration of the plate replacing apparatus C after the completion of the step of removing the old plate 25. FIG. 11 is an enlarged front view of the partial plate replacing apparatus C shown in FIG. 10. FIG. 12A is a cross-sectional view of the plate replacing apparatus C along the line E-E shown in FIG. 11. FIG. 12B is a cross-sectional view of the plate replacing apparatus C along the line W-W shown in FIG. 11. FIG. 12C is a cross-sectional view of the plate replacing apparatus C along the line V-V shown in FIG. 11.

The plate replacing apparatus C includes plate-holding guide rollers 41 and 42. The plate-holding guide rollers 41 and 42 hold the old plate 25 inside the plate replacing apparatus C. When the old plate 25 is going to be removed from the plate cylinder 24, the plate-holding guide rollers 41 and 42 first receive the old plate 25 in their lower portions. As the old plate 25 is further removed from the plate cylinder 24, a rod 44 of an air cylinder 43 is extended, so that the plate-holding guide rollers 41 and 42 come upwards. In addition, when a clamping lever 40 is more slanted than a lever 40′, the plate-holding guide rollers 41 and 42 finally hold and raise the old plate 25 upwards. Incidentally, a rack 45 on which the plate-holding guide rollers 41 and 42 are provided is raised upwards along a translatory guide rail 46 precisely.

According to the invention, each of the plate-holding guide rollers 41 and 42, which hold and rotatably support the old plate 25, includes one-way clutches 41C and 42C. Both of the one-way clutches 41C and 42C or at least either one of the one-way clutches 41C and 42C can be provided in the plate-holding guide rollers 41 and 42. The one-way clutches 41C and 42C are clutches constrained to rotate only in one direction. In a case shown in FIG. 10, the plate-holding guide rollers 41 and 42 rotate only in the same direction as a direction in which the old plate 25 rotates when the old plate 25 comes upwards. Therefore, the plate-holding guide rollers 41 and 42 stand by with holding the old plate 25, and can rotate in a direction in which the old plate 25 is pulled out from above, but cannot rotate in a direction in which the old plate 25 is pushed therein. Thus, it is possible to prevent the old plate 25 from being dropped down accidentally, and thus the old plate 25 can avoid getting scratched. Recently, it tends to print various types of printed matters in small lots in most cases, so that an old plate is frequently replaced with a new one. On the other hand, the same plate is used repeatedly in some cases. Therefore, from the viewpoints of preventing a degradation of a plate and keeping a quality of the plate, these one-way clutches are effective.

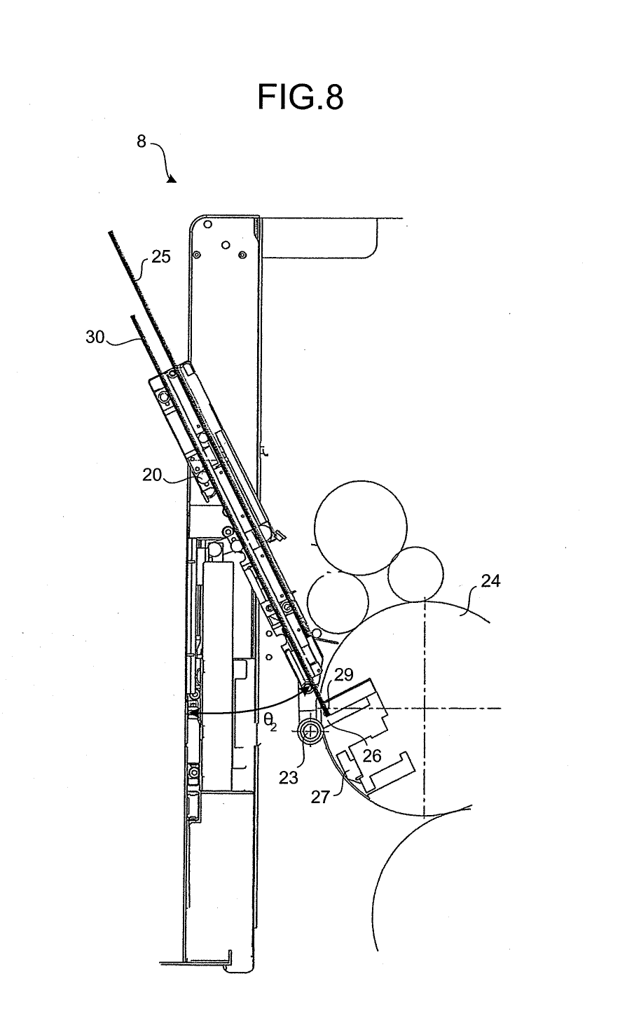

FIG. 8 is a side view of the plate replacing apparatus C when the new plate 30 is wound around the plate cylinder 24 after the completion of removing the old plate 25. When the old plate 25 is removed from the plate cylinder 24, the plate replacing apparatus C winds the new plate 30 around the plate cylinder 24. At this time, the plate replacing apparatus C further rotates around the rotation shaft 20 at an angle θ₂ from the former standby position where the plate replacing apparatus C is positioned during removal of the old plate 25. In this state, the plate-replacement supporting roller 23 is pressed on the plate cylinder 24 harder than that is when the old plate 25 is removed from the plate cylinder 24. This is because a portion where the vice of the plate cylinder 24 is located is not an arc surface but a surface that includes a flat surface and varies in height. Therefore, the plate-replacement supporting roller 23 needs to be pressed on the surface harder to closely contact with each other.

When the plate-replacement supporting roller 23 is pressed on the portion where the vice is located, a semicircular notch provided at a tip of the new plate 30 contacts a register pin 29 (see FIG. 8) provided inside the gripper-end-side chuck 26 of the plate cylinder 24. At this time, i.e., when the old plate 25 is going to be removed, the gripper-end-side chuck 26 is already opened. Then, when the notch at the tip of the new plate 30 and the register pin 29 are fitted with each other, the gripper-end-side chuck 26 is closed, and the plate cylinder 24 rotates counterclockwise. At this time, the plate-replacement supporting roller 23 presses the new plate 30 on the plate cylinder 24 hard.

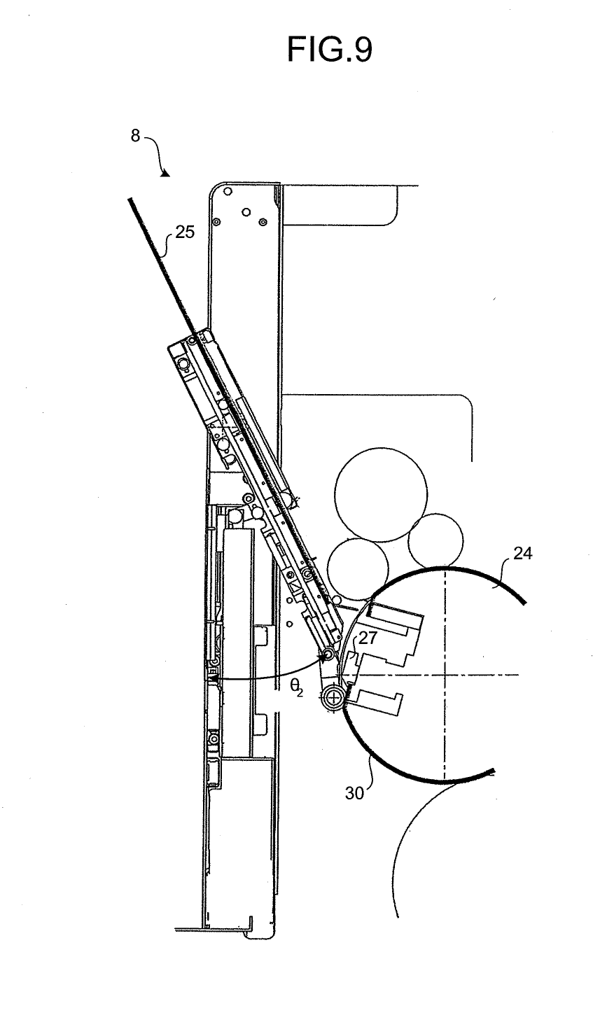

FIG. 9 is a side view of the plate replacing apparatus C when the new plate 30 is wound around the plate cylinder 24. When the plate-replacement supporting roller 23 comes to a position in front of the trailing-end-side chuck 27 by pressing the new plate 30 hard, the trailing-end-side chuck 27 is closed. Then, the new plate 30 is completely wound around the plate cylinder 24. After the completion of winding of the new plate 30, the plate replacing apparatus C rotates at the angle θ₂ to get back to the standby position shown in FIG. 7.

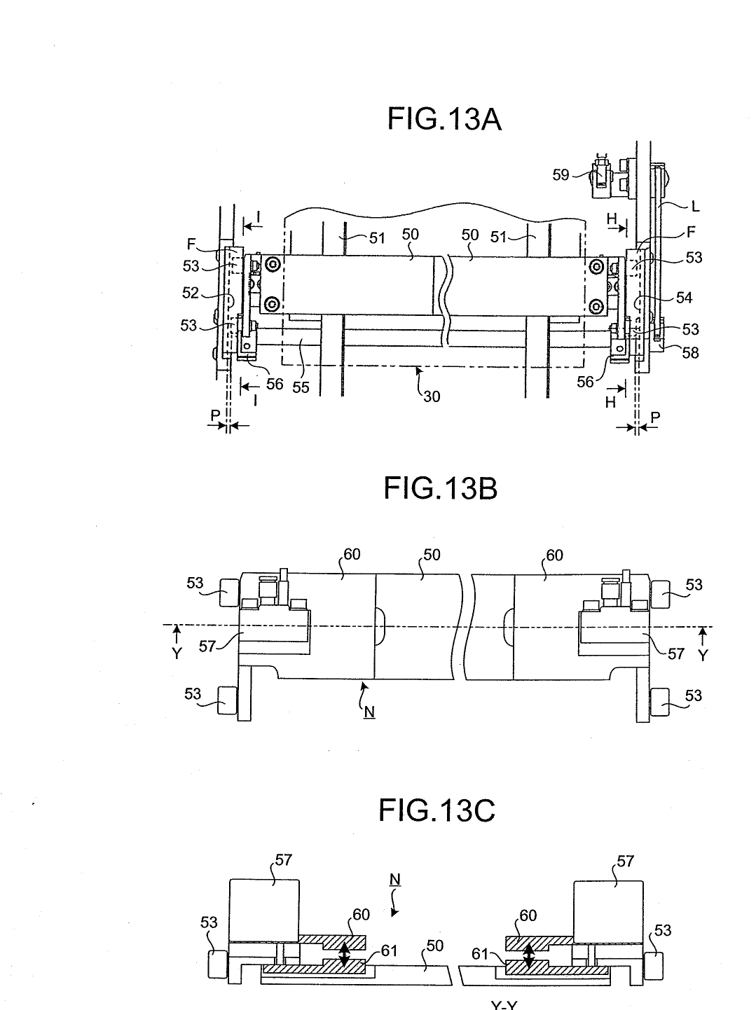

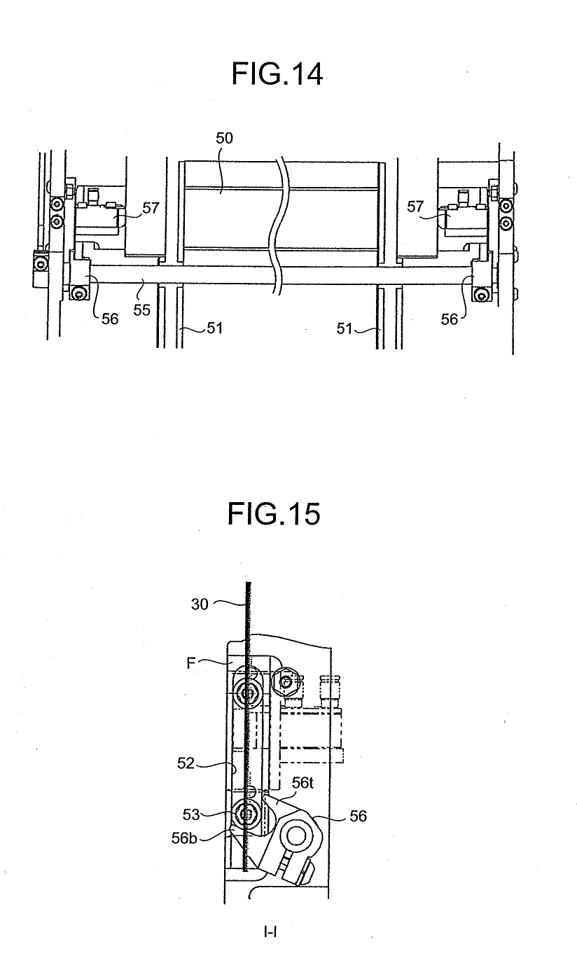

FIGS. 13A to 13C are respectively front views and a cross-sectional view of the new-plate holding unit N provided on a new-plate insertion path of the plate replacing apparatus C. Specifically, FIG. 13A shows a portion of the plate replacing apparatus C, which can be seen when a steel-plate part of the upper portion 13 shown in FIG. 4 is removed. FIG. 13B shows the new-plate holding unit N provided on the reverse side of the connecting plate 50. FIG. 13C is a cross-sectional view of the new-plate holding N unit along the line Y-Y shown in FIG. 13B. FIG. 14 is a rear view of the new-plate holding unit N shown in FIG. 13A.

The new-plate holding unit N as shown in FIGS. 13A to 14 is provided along the sides of the plate cylinder 24 (the inner side of the plate replacing apparatus C), i.e., at both ends of the connecting plate 50 shown in FIG. 4, and holds both ends of the new plate 30 on the new-plate insertion path. At this time, an air cylinder 57 is used to control holding the both ends of the new plate 30. Specifically, a gap between a lower claw member 61 and a fixed upper claw member 60 of the new-plate holding unit N is controlled by an expansion/contraction of a rod (not shown) of the air cylinder 57. The new plate 30 is held between the lower claw member 61 and the upper claw member 60.

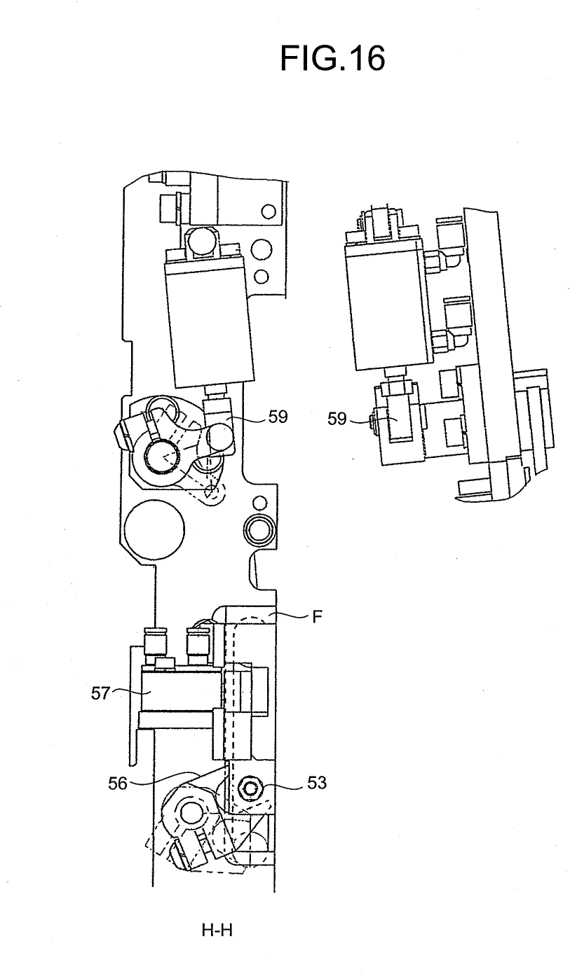

FIG. 15 is a cross-sectional view of the new-plate holding unit N along the line I-I shown in FIG. 13A. FIG. 16 is a cross-sectional view of the new-plate holding unit N along the line H-H shown in FIG. 13A. As shown in FIGS. 15 and 16, a columnar lug 53 is protruded in a width direction of the new plate 30, but actually fitted in grooves 52 and 54 provided on the sub-frame F (see FIG. 13A). The upper claw member 60 is integrally coupled to the columnar lug 53, and also fixed to the connecting plate 50. Furthermore, the air cylinder 57 is coupled to the upper claw member 60, so that the lower claw member 61 relatively moves with respect to the upper claw member 60 when the air cylinder 57 is driven, and thereby making the gap opened/closed. The new-plate holding unit N is constrained to move only in a direction in which the new plate 30 is inserted with having a margin P in a width direction of the new plate 30 by a movement constraining unit composed of a combination of the columnar lug 53 and the grooves 52 and 54.

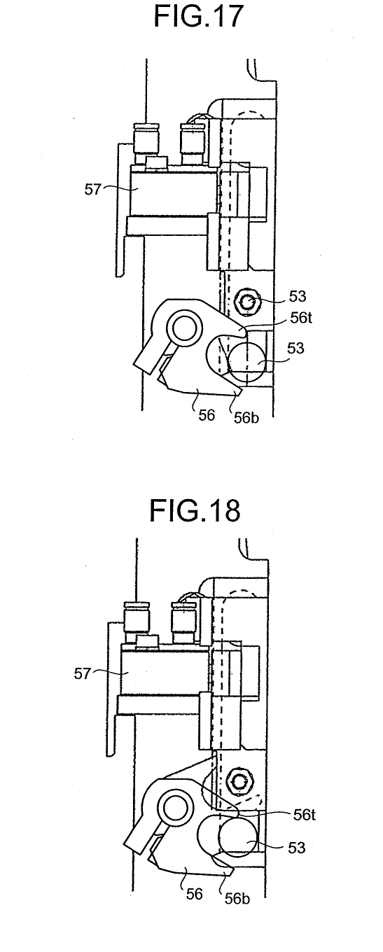

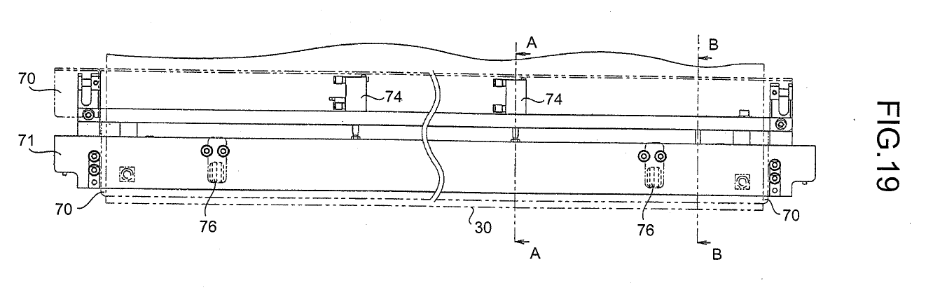

Approximately horseshoe-shaped or U-shaped plate-introduction rotating units 56 are provided beside the columnar lugs 53 provided on the bottom right and bottom left sides respectively. The plate-introduction rotating units 56 provided on the both sides of the plate insertion path are coupled to each other by a penetrating shaft 55 (see FIGS. 13A and 14). As an end portion 58 of the penetrating shaft 55 rotates in accordance with a rotation of a drive link L that is driven by an air cylinder 59, the plate-introduction rotating units 56 also rotate in synchronization with the end portion 58. Before the new plate 30 is inserted towards the plate cylinder 24 (for example, in a state shown in FIG. 6), the plate-introduction rotating units 56 hold, as shown in FIG. 15, the columnar lugs 53 of the new-plate holding unit N by using their lower jaws 56b. When the new plate 30 is inserted towards the plate cylinder 24, as shown in FIGS. 17 and 18, the plate-introduction rotating units 56 rotate in a downward direction by controlling the air cylinder 59, and then the columnar lugs 53 are released in the direction in which the new plate 30 is inserted.

An angle when the plate-introduction rotating units 56 stop rotating is to be defined as an angle when the columnar lugs 53 contact neither upper jaws 56t nor the lower jaws 56b as shown in FIG. 17 in a state that the notch provided at the tip of the new plate 30 is fitted in the register pin 29 (see FIG. 8) of the plate cylinder 24, and also when the columnar lugs 53 are pressed by the upper jaws 56t in a state that the notch of the new plate 30 is located short of the position where the notch is fitted in the register pin 29 (from any causes, for example, such that the new plate 30 is stuck in midstream, or positions of the notch and the register pin 29 are displaced with each other).

In this manner, the new-plate holding unit N has the margin P in the width direction of the new plate 30. Therefore, even though the notch provided at the tip of the new plate 30 and the register pin 29 of the plate cylinder 24 are slightly displaced with each other, if an amount of the displacement is smaller than the margin P (for example, 1 mm to 2 mm), the notch and the register pin 29 can be easily fitted with each other because of a self-aligning effect of the semicircular-shaped notch. Also, in the direction in which the new plate 30 is inserted, the plate-introduction rotating units 56 do not always force the register pin 29, but rocks the notch and the register pin 29 to be fitted with each other, as if the notch and the register pin 29 were gently rocked by human beings. Therefore, it is possible to reduce damage on the plate.

Furthermore, even though a positioning angle of the plate cylinder 24 is slightly displaced (for example, relatively 1 mm in a circumferential direction), in the same manner as above, the upper jaws 56t of the plate-introduction rotating units 56 rotate to press the columnar lugs 53. Therefore, the plate held by the new-plate holding unit N can be pressed until the notch and the register pin 29 can be fitted with each other. According to the embodiment, the margin P is also provided in the width direction of the plate, and the notch and the register pin 29 can be fitted with each other in a longitudinal direction by the plate-introduction rotating units 56, which mainly uses a weight of the plate. Even in a case in which the plate or the new-plate holding unit N is pressed by using a spring instead of the plate-introduction rotating units 56, as long as there is the margin P in the width direction of the plate, the notch of the plate and the register pin 29 of the plate cylinder can be easily fitted with each other.

Namely, as for a configuration of the printing press, the printing press is configured to include the plate replacing apparatus that includes a new-plate holding unit for holding a surface of a new plate in a width direction of the new plate on a new-plate insertion path, a movement constraining unit for constraining the new-plate holding unit to move only in a direction in which the new plate is inserted within a frame in which the new-plate holding unit is contained with having a margin in the width direction of the new plate, a pressing unit configured to press the new-plate holding unit to move a distance equivalent to a moving distance of the new plate to be inserted towards a plate cylinder, which is being held by the new-plate holding unit, in a direction in which the new-plate holding unit is constrained at a certain press force by the movement constraining unit, and a position returning unit configured to press the new-plate holding unit to be returned back from a position where the new-plate holding unit is pressed to a position where the new-plate holding unit is located before being pressed, so that when the new plate is inserted towards the plate cylinder, a slight displacement can be absorbed by a portion of the margin provided in a lateral direction. Therefore, the new plate can be inserted towards the plate cylinder precisely. Thus, it is possible to position the plate with high precision by preventing a notch provided at a tip of the plate from being damaged. Incidentally, the position returning unit is required to return back from a state in which the new-plate holding unit is pressed by a spring. Alternatively, the position returning unit can be composed of a commonly used medium, such as a cam and a spring.

To the contrary, in a case in which the plate-introduction rotating units 56 are used without having the margin P in the width direction of the new plate, the plate-introduction rotating units 56 do not force to press the new plate in the direction in which the new plate is inserted, but inserts the new plate towards the plate cylinder as if a human beings gently and softly rocked the new plate. Therefore, even in this case, the notch of the plate and the register pin 29 of the plate cylinder can be precisely fitted with each other.

As for a configuration of the printing press in the case in which the plate-introduction rotating units 56 are used without having the margin P in the width direction of the new plate, specifically, the printing press is configured to include the plate replacing apparatus that includes a new-plate holding unit for holding a surface of a new plate in a width direction of the new plate on a new-plate insertion path, a movement constraining unit for constraining the new-plate holding unit to move only in a direction in which the new plate is inserted by fitting a columnar lug protruded from the new-plate holding unit in the width direction of the new plate in a groove provided on a frame in which the new-plate holding unit is contained, and a plate-introduction rotating unit that is an approximately horseshoe-shaped or U-shaped rotating unit, and configured to hold the columnar lug protruded from the new-plate holding unit on its lower jaw before the new plate is inserted towards the plate cylinder, and to release the columnar lug protruded from the new-plate holding unit in the direction in which the new plate is inserted by rotating downwards when the new plate is inserted towards the plate cylinder, and to define an angle when the plate-introduction rotating unit stops rotating as an angle when the columnar lug contacts neither an upper jaw nor the lower jaw in a state that a notch provided at a tip of the new plate is fitted in the register pin 29 of the plate cylinder, and also when the columnar lug is pressed by the upper jaw in a state that the notch is located short of a position where the notch is fitted in the register pin 29.

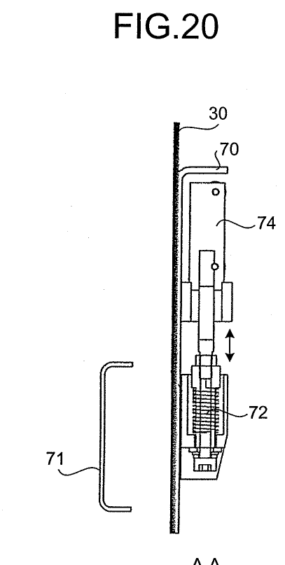

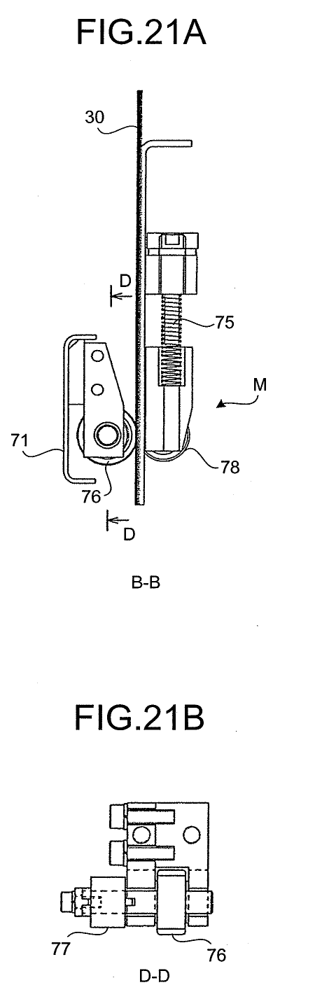

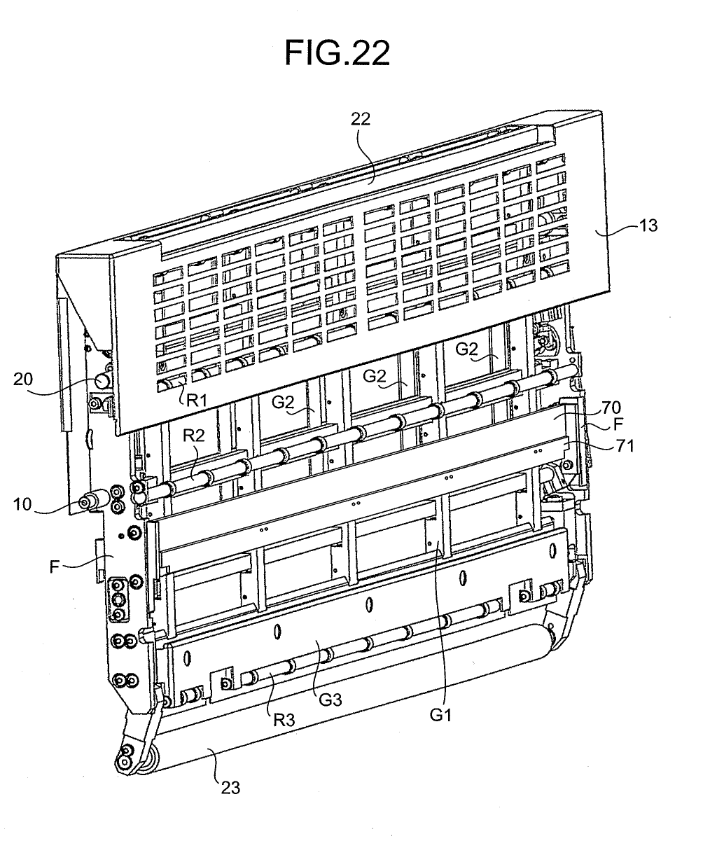

FIG. 19 is an external view for explaining a configuration of a plate-insertion type of a plate replacing apparatus with a torque limiter according to a variation of the present invention. FIG. 20 is a cross-sectional view of the plate replacing apparatus along the line A-A shown in FIG. 19. FIG. 21A is a cross-sectional view of the plate replacing apparatus along the line B-B shown in FIG. 19. FIG. 21B is a cross-sectional view of the plate replacing apparatus along the line D-D shown in FIG. 21A. A guide plate 70 shown in FIG. 19 is secured to the frame of the plate replacing apparatus C. As shown in FIG. 22, it is considered that the configuration shown in FIGS. 19 to 21B can be replaced with the new-plate holding unit N including the connecting plate 50 shown in FIG. 4.

In the configuration, a plate holding roller 76 is provided behind a cover 71, and a roller 78 is provided on the side of the guide plate 70, which is the opposite side of the plate holding roller 76. The new plate 30 is held between the plate holding roller 76 and the roller 78. Namely, a new-plate holding unit M according to the present variation is composed of the plate holding roller 76 and the roller 78.

In the configuration shown in FIGS. 20 and 21A, the new plate 30 is inserted towards the plate cylinder basically by using an air cylinder 74 and press-force adjusting springs 72 and 75. Furthermore, as shown in FIG. 21B, according to the present variation, a torque limiter 77 is provided on the same shaft as that of the plate holding roller 76. Namely, the plate replacing apparatus with the torque limiter includes the new-plate holding unit M for holding a surface of the new plate 30 in the width direction of the new plate 30 on the new-plate insertion path, the plate holding roller 76 (the roller guide) for exposing the surface of the new plate 30 held by the new-plate holding unit M, and the roller 78, and then the torque limiter 77 is provided on the plate holding roller 76.

The new plate 30 is held by the plate holding roller 76, and the torque limiter 77 is provided on the rotation shaft of the plate holding roller 76. Therefore, when a certain degree of pressing load is applied to the new plate 30, the plate holding roller 76 rotates. Then, the new plate 30 moves in accordance with the rotation of the plate holding roller 76. Namely, the new plate 30 can be pressed on the register pin 29 (see FIG. 8) at a predetermined press force, and thus the plate positioning can be made precisely. Consequently, the notch of the new plate 30, which is pressed on the register pin 29, can be prevented from a deformation. Incidentally, it is possible to combine the plate replacing apparatus with the torque limiter and the plate replacing apparatus as shown in FIG. 13A, which includes the movement constraining unit composed of the grooves 52 and 54 and the columnar lug 53 and the margin P, and thereby establishing a new-plate insertion mechanism having the both characteristics.

As explained above, the printing press according to the embodiments of the present invention makes it possible to include the plate replacing apparatus that includes a new-plate insertion mechanism capable of inserting a new plate towards a plate cylinder precisely without exerting an unnecessary force on the new plate and a mechanism for preventing an old plate from being dropped.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A printing press comprising a plate replacing apparatus, wherein the plate replacing apparatus includes
a new-plate holding unit that holds a surface of a new plate in a width direction on a new-plate insertion path;
a movement constraining unit that constrains the new-plate holding unit to move in a direction of inserting the new plate between the new-plate holding unit and a frame in which the new-plate holding unit is mounted, with a margin in the width direction of the new plate;
a pressing unit that presses the new-plate holding unit in a direction in which the new-plate holding unit is constrained with a constant force by a distance equivalent to a moving distance of the new plate held by the new-plate holding unit to be inserted towards a plate cylinder; and
a position returning unit that presses the new-plate holding unit to be returned from a position where the new-plate holding unit is pressed to a position where the new-plate holding unit is located before being pressed.

2. A printing press comprising a plate replacing apparatus, wherein the plate replacing apparatus includes
a new-plate holding unit that holds a surface of a new plate in a width direction on a new-plate insertion path;
a movement constraining unit that constrains the new-plate holding unit to move in a direction of inserting the new plate by fitting a columnar lug protruded from the new-plate holding unit in the width direction of the new plate in a groove provided on a frame in which the new-plate holding unit is mounted; and
a plate-introduction rotating unit that is an approximately horseshoe-shaped rotating unit, the plate-introduction rotating unit holding the columnar lug protruded from the new-plate holding unit on its lower jaw before the new plate is inserted towards the plate cylinder, releasing the columnar lug protruded from the new-plate holding unit in the direction in which the new plate is inserted by rotating downwards when the new plate is inserted towards the plate cylinder, and defining an angle when the plate-introduction rotating unit stops rotating as an angle when the columnar lug contacts neither an upper jaw nor the lower jaw in a state that a notch provided at a tip of the new plate is fitted in a pin of the plate cylinder, and also when the columnar lug is pressed by the upper jaw in a state that the notch is located short of a position where the notch is fitted in the pin.

3. A printing press comprising a plate replacing apparatus, wherein the plate replacing apparatus includes
a new-plate holding unit that holds a surface of a new plate in a width direction on a new-plate insertion path;
a movement constraining unit that constrains the new-plate holding unit to move in a direction of inserting the new plate by fitting a columnar lug protruded from the new-plate holding unit in the width direction of the new plate in a groove provided on a frame in which the new-plate holding unit is contained, with a margin in the width direction of the new plate; and
a plate-introduction rotating unit that is an approximately horseshoe-shaped rotating unit, the plate-introduction rotating unit holding the columnar lug protruded from the new-plate holding unit on its lower jaw before the new plate is inserted towards the plate cylinder, releasing the columnar lug protruded from the new-plate holding unit in the direction in which the new plate is inserted by rotating downwards when the new plate is inserted towards the plate cylinder, and defining an angle when the plate-introduction rotating unit stops rotating as an angle when the columnar lug contacts neither an upper jaw nor the lower jaw in a state that a notch provided at a tip of the new plate is fitted in a pin of the plate cylinder, and also when the columnar lug is pressed by the upper jaw in a state that the notch is located short of a position where the notch is fitted in the pin.

4. A printing press comprising a plate replacing apparatus, wherein the plate replacing apparatus includes
a new-plate holding unit that holds a surface of a new plate in a width direction on a new-plate insertion path; and
a roller guide that exposes the surface of the new plate held by the new-plate holding unit, the roller guide including a torque limiter.

5. A printing press comprising a plate replacing apparatus that includes a mechanism for removing an old plate wound around a plate cylinder, wherein
the mechanism includes plate-holding guide rollers for holding the old plate, and
a one-way clutch is provided on at least one of the plate-holding guide rollers.
